(19) United States
(12) Patent Application Publication
(10) Pub. No.: US 2011/0267239 A1
(43) Pub. Date: Nov. 3, 2011

(54) PORTABLE RADIO DEVICE

(75) Inventors: Nobuharu Mashima, Toyama (JP); Tadashi Oga, Kanagawa (JP); Shoichi Kajiwara, Osaka (JP); Kiyoshi Nakanishi, Kanagawa (JP)

(73) Assignee: PANASONIC CORPORATION, Osaka (JP)

(21) Appl. No.: 13/143,283

(22) PCT Filed: Nov. 20, 2009
(86) PCT No.: PCT/JP2009/006275

§ 371 Date: Jul. 5, 2011

(30) Foreign Application Priority Data
Jan. 6, 2009 (JP) 2009-000615

(51) Int. Cl. H01Q 1/24

(52) U.S. Cl. 343/702

(57) ABSTRACT

A portable radio device includes: a housing made of non-conductor having a first permittivity; a circuit board disposed in the housing; a radio circuit disposed on the circuit board; an antenna element connected to the radio circuit; and a dielectric body. The dielectric body is disposed substantially in a center of the housing in a lateral direction thereof and has a second permittivity higher than the first permittivity.

### TECHNICAL FIELD

The present invention relates to a portable radio device such as a cellular phone or a PHS (personal handy phone system).

### BACKGROUND ART

Up to now, in portable radio devices such as cellular phones or PHSs, for example, Patent Document 1 to Patent Document 3 have proposed an improvement in radiation efficiency of electric waves. In a compact cellular phone disclosed in Patent Document 1 has a folding structure in which a planar antenna having an outward directionality is provided inside each of two housings, and a distance between those two planar antennas is made equal to or larger than at least a width of a palm in a state where a main body is opened. Also, in a radio terminal device disclosed in patent Document 2, a radiator as well as a parasitic element longer than a radiation element of the radiator by 0.01λ to 0.1λ are arranged at a distance of 0.01λ to 0.1λ. Also, an antenna disclosed in Patent Document 3 includes a feed element, a parasitic element arranged at a given distance from the feed element, and a magnetic body laminated on a surface of the parasitic element which is oriented toward at least the feed element side.

### RELATED ART DOCUMENTS

### Patent Documents

Patent Document 1: JP-A-2002-223107
Patent Document 2: JP-A-2002-171190
Patent Document 3: JP-A-2006-222873

### SUMMARY OF THE INVENTION

### Problem to be Solved by the Invention

However, the conventional portable radio device suffers from a problem that the sensitivity is decreased during reception as much as electric waves are absorbed by bringing a radio device main body close to a face or gripping the radio device main body. Each of the techniques disclosed in the above-mentioned Patent Documents 1 to 3 improves the radiation efficiency of electric waves. However, the techniques of Patent Documents 1 and 2 suffers from a problem that the costs increase because at least two antennas are required, and the technique of Patent Document 3 suffers from a problem that the characteristics are changed by bringing a hand or face of a user close to the radio device main body. The amount of energy absorbed by an organization of a unit mass per unit time by exposing a human body to electric waves is called SAR (specific absorption rate). As represented by the SAR, the conventional portable radio device increases the SAR value when the portable radio device is brought close to the face, or the portable radio device is held by the hand.

The present invention has been made in view of the above circumstances, and aims at providing a portable radio device that can reduce a power absorption by the face or hand of a human body at low costs to improve a speech performance.

### Means for Solving the Problem

According to the present invention, there is provided a portable radio device including: a housing made of non-conductor having a first permittivity; a circuit board disposed in the housing; a radio circuit disposed on the circuit board; an antenna element connected to the radio circuit; and a dielectric body disposed substantially in a center of the housing in a lateral direction thereof and having a second permittivity higher than the first permittivity.

According to the above configuration, a portion of the housing which is not directly touched by a hand is made of the dielectric body having the second permittivity higher than the first permittivity. As a result, an electric field is concentrated on an end portion of the dielectric body, and an energy density in portions other than the end portion of the dielectric body is reduced whereby the power absorption into the hand is reduced by gripping the portion other than the dielectric body by the hand (that is, an influence of the human hand is reduced). Thus, the portion of the housing which is not directly touched by the hand is made of the higher dielectric body, and the portion of the housing which is directly touched by the hand is made of the lower dielectric body, thereby enabling the power absorption into the hand to be reduced. As a result, the speech performance is improved as compared with the conventional art, the sensitivity is improved during reception, and the transmission output is improved during transmission. Also, since the dielectric body is merely added, an increase in the costs can be minimized. This invention is suitable for a straight type portable radio device having one housing.

According to the present invention, there is provided a portable radio device including: a first housing made of non-conductor having a first permittivity; a second housing made of non-conductor having the first permittivity; a hinge part that rotatably couples the first housing and the second housing; a circuit board disposed in the second housing; a radio circuit disposed on the circuit board; an antenna element connected to the radio circuit and disposed closer to the hinge part in the second housing; and a dielectric body disposed substantially in a center of at least one of the first housing and the second housing in a lateral direction thereof and having a second permittivity higher than the first permittivity.

According to the above configuration, a portion of at least one of the first housing and the second housing which is not directly touched by a hand is made of the dielectric body having the second permittivity higher than the first permittivity. As a result, an electric field is concentrated on an end portion of the dielectric body, and an energy density in portions other than the end portion of the dielectric body is reduced whereby the power absorption into the hand is reduced by gripping the portion other than the dielectric body by the hand (that is, an influence of the human hand is reduced). Thus, the portion of the housing which is not directly touched by the hand is made of the higher dielectric body, and the portion of the housing which is directly touched by the hand is made of the lower dielectric body, thereby enabling the power absorption into the hand to be reduced. As a result, the speech performance is improved as compared with the conventional art, the sensitivity is improved during reception, and the transmission output is improved during transmission. Also, since the dielectric body is merely added, an increase in the costs can be minimized. This invention is suitable for a folding portable radio device having a housing formed of two portions.

In the above configuration, sound emitting means is provided, and the dielectric body is disposed on an opposite side of the sound emitting means in a thickness direction of the housing.

According to the above configuration, when the sound emitting means is a speaker that outputs sound, since the speaker comes closest to a human ear, the dielectric body is disposed at an opposite side of the speaker in the thickness direction of the housing, to thereby reduce the power absorption into the human face. That is, since the dielectric body is disposed in a direction away from the human face, the power absorption into the human face is reduced.

Also, in the above configuration, when the dielectric body is disposed in each of the first housing and the second housing, the permittivity of the dielectric body is different between the first housing and the second housing.

According to the above configuration, since the permittivity of the dielectric body is different between the first housing and the second housing, the electric field can be concentrated on the end portion of the dielectric body higher in the permittivity.

### Advantages of the Invention

According to the present invention, a portion of the housing which is not directly touched by a human hand or face is made of the dielectric body having the permittivity higher than that of the other portions. With this configuration, an electric field is concentrated on an end portion of the dielectric body, and an energy density in portions other than the end portion of the dielectric body is reduced whereby the power absorption into the human hand or face is reduced. As a result, the speech performance is improved as compared with the conventional art, the sensitivity is improved during reception, and the transmission output is improved during transmission. Also, since the dielectric body is merely added, an increase in the costs can be minimized.

### BRIEF DESCRIPTION OF THE DRAWINGS

FIG. 1 is a back view illustrating an exterior of a portable radio device according to a first embodiment of the present invention.

FIG. 2 is a diagram illustrating a state in which the portable radio device of FIG. 1 is in use.

FIG. 3 is a diagram illustrating an example in which a dielectric body is disposed in a lower housing of the portable radio device of FIG. 1.

FIG. 4 is a perspective view illustrating an exterior of a portable radio device according to a second embodiment of the present invention.

FIG. 5 is a schematic diagram illustrating a position of the dielectric body in the portable radio device of FIG. 4.

### MODE FOR CARRYING OUT THE INVENTION

Hereinafter, preferred embodiments for carrying out the present invention will be described in detail with reference to the drawings.

### First Embodiment

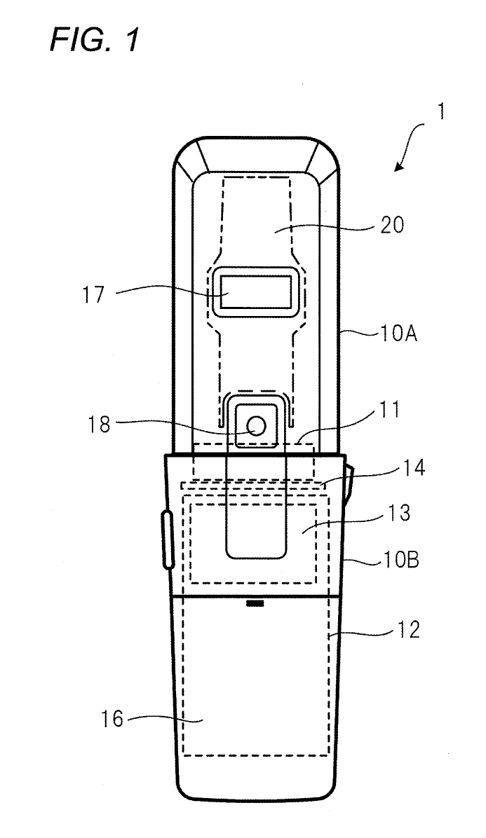

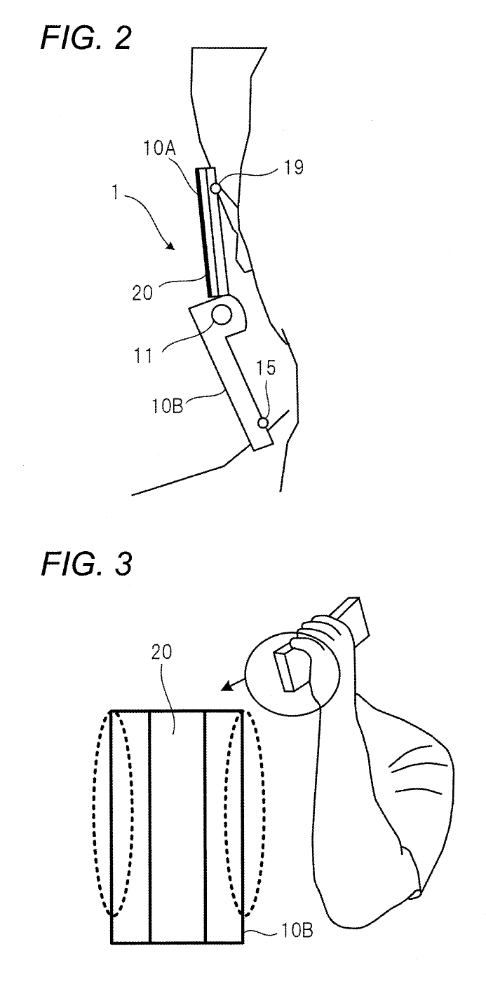

FIG. 1 is a back view illustrating an exterior of a portable radio device according to a first embodiment of the present invention. FIG. 2 is a diagram illustrating a state in which the portable radio device of FIG. 1 is in use. Referring to FIGS. 1 and 2, a portable radio device 1 according to this embodiment is a folding portable radio device having a housing made up of two portions of an upper housing (first housing) 10A and a lower housing (second housing) 10B. Each of the upper housing 10A and the lower housing 10B is made of non-conductor having a first permittivity. The upper housing 10A and the lower housing 10B are rotatably coupled to each other by a hinge part 11.

A circuit board 12 is incorporated into the lower housing 10B, and a radio circuit 13 is mounted on the circuit board 12. The radio circuit 13 is connected with an antenna element 14 disposed at the hinge part 11 side of the lower housing 10B. Also, on a front side of the lower housing 10B are disposed a key operation part (not shown) such as a numerical keypad or function keys, and a microphone 15 (refer to FIG. 2). Also, on a back side of the lower housing 10B is disposed a cover 16 (refer to FIG. 1) that closes a portion accommodating a battery (not shown).

On a back side of the upper housing 10A are disposed a sub-display unit 17 and a camera 18, and on a front side thereof are disposed a main display unit (not shown) and a speaker 19 (refer to FIG. 2). The speaker 19 corresponds to sound emitting means, and outputs sound of a communication partner. Also, on a bottom of an interior of the upper housing 10A is disposed a dielectric body 20 having a second permittivity higher than the first permittivity substantially in the center of the upper housing 10A in a lateral direction. In this case, since the upper housing 10A is provided with a window part (not shown) opened for the sub-display unit 17 and the camera 18, the dielectric body 20 is disposed to avoid those components. The bottom of the interior of the upper housing 10A is a surface facing the sub-display unit 17 and the camera 18 (in fact, not a facing surface since the sub-display unit 17 and the camera 18 are exposed from the window part opened in the upper housing 10A, but the facing surface when it is assumed that the facing face are provided).

The dielectric body 20 is, for example, a high dielectric body formed in a thin sheet shape, and adhered onto the upper housing 10A with a double-faced adhesive tape. Except that the dielectric body 20 is shaped in the thin sheet shape and adhered thereto with the double-faced adhesive tape, it is possible that the high dielectric body is evaporated and attached (vapor-deposited) on the bottom of the interior of the upper housing 10A. The high dielectric body is preferably made of a ceramic material (100 or lower in relative permittivity), and for example, as paraelectrics intended for high frequency wave, there are forsterite, aluminum oxide, barium magnesium niobate, and barium neodymium titanate.

With the provision of the dielectric body 20 having the second permittivity higher than the first permittivity of the upper housing 10A in the upper housing 10A, an electric field is concentrated on an end portion of the dielectric body 20, and an energy density in portions other than the dielectric body 20 is reduced. As a result, the power absorption into the human face is reduced. In particular, since the dielectric body 20 is arranged at an opposite side of the speaker 19 in the thickness direction of the upper housing 10A (arranged in a direction away from the human face), the power absorption into the human face can be effectively reduced. As a result, the speech performance is improved as compared with the conventional portable radio device having no dielectric body 20. That is, the sensitivity is improved during reception, and the transmission output is improved during transmission.

As described above, according to the portable radio device 1 of this embodiment, since the dielectric body 20 having the second permittivity higher than the first permittivity is disposed substantially in the center of the upper housing 10A in the lateral direction of the upper housing 10A on the bottom of the interior of the upper housing 10A. With this configuration, the electric field is concentrated on the end portion of the dielectric body 20, and the energy density in portions other than a portion where the dielectric body 20 is disposed is reduced. As a result, the power absorption into the human face is reduced, and the speech performance is improved as compared with the conventional portable radio device having no dielectric body 20. Also, since the dielectric body 20 is merely added, an increase in the costs can be minimized.

In this embodiment, the dielectric body 20 is provided only in the upper housing 10A. Also, the same dielectric body 20 may be disposed in the lower housing 10B as illustrated in FIG. 3. In particular, in the folding portable radio device 1, since the lower housing 10B is mostly gripped, the dielectric body 20 is disposed in the lower housing 10B as illustrated in FIG. 3 with the result that an influence of the human hand can be reduced. Similarly, in this case, it is needless to say that the speech performance is improved. In FIG. 3, portions indicated by dotted lines are touched with the hand. It is desirable that a position of the lower housing 10B to which the dielectric body 20 is fitted is on a rear surface of the cover 16. In this case, a high dielectric body formed in the thin sheet shape is adhered thereto with a double-faced adhesive tape, or the high dielectric body is vapor-deposited on the rear surface of the cover 16.

Also, when the dielectric body 20 is disposed on each of the upper housing 10A and the lower housing 10B, the permittivity of the dielectric body 20 may be different between the upper housing 10A and the lower housing 10B.

### Second Embodiment

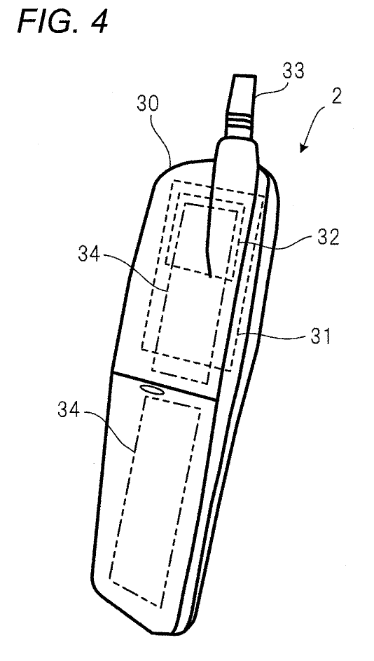

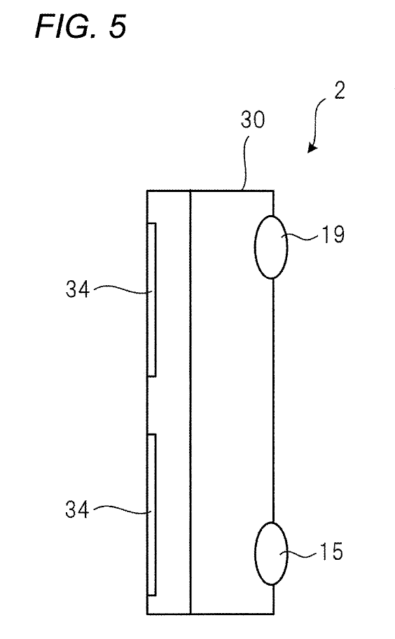

FIG. 4 is a perspective view illustrating an exterior of a portable radio device according to a second embodiment of the present invention. In the figure, a portable radio device 2 according to this embodiment is a straight type portable radio device having one housing 30. The housing 30 is made of non-conductor having a first permittivity. A circuit board 31 is incorporated into an upper part of the housing 30, and a radio circuit 32 is mounted on the circuit board 31. The radio circuit 32 is connected with an antenna element 33. A dielectric body 34 having a second permittivity higher than the first permittivity of the housing 30 is disposed substantially in the center of each of the upper part and a lower part of the housing 30 in a lateral direction. That is, the dielectric body 34 is disposed on each of a bottom of an upper interior of the housing 30 and a bottom of a lower interior of the housing 30. In this case, the bottom is one surface opposite to the other surface on which a display unit (not shown) is disposed in the case of the upper part of the housing 30, and one surface opposite to the other surface on which a key operation unit (not shown) is disposed in the case of the lower part of the housing 30.

Each of the dielectric bodies 34 is, for example, a high dielectric body formed in a thin sheet shape, and adhered onto the housing 30 with a double-faced adhesive tape, as with the dielectric body 20 described in the first embodiment. Except that each of the dielectric bodies 34 is shaped in the thin sheet shape and adhered thereto with the double-faced adhesive tape, it is possible that the high dielectric body is evaporated and attached (vapor-deposited) on the bottom of the upper interior of the housing 30, and the bottom of the lower interior of the housing 30. The high dielectric body is preferably made of a ceramic material (100 or lower in relative permittivity), and for example, as paraelectrics intended for high frequency wave, there are forsterite, aluminum oxide, barium magnesium niobate, and barium neodymium titanate.

With the provision of the dielectric bodies 34 having the second permittivity higher than the first permittivity in the upper part and the lower part of the housing 30, an electric field is concentrated on the dielectric bodies 34, and an energy density in portions other than the dielectric bodies 34 is reduced. As a result, the power absorption into the human face or hand is reduced. In particular, since the dielectric bodies 34 are arranged at an opposite side of the speaker 19 in the thickness direction of the housing 30, the power absorption into the human face can be effectively reduced. As a result, the speech performance is improved as compared with the conventional portable radio device having no dielectric body 34. That is, the sensitivity is improved during reception, and the transmission output is improved during transmission. When the dielectric body 34 is disposed on each of the upper part and the lower part of the housing 30, the permittivity of the dielectric body 34 may be different between the upper part and the lower part of the housing 30.

As described above, according to the portable radio device 2 of this embodiment, with the provision of the dielectric bodies 34 having the second permittivity higher than the first permittivity in the upper part and the lower part of the housing 30, an electric field is concentrated on the respective dielectric bodies 34, and an energy density in portions other than the portions where the dielectric bodies 34 are provided is reduced. As a result, since the power absorption into the human face or hand is reduced, the speech performance is improved as compared with the conventional portable radio device having no dielectric bodies 34. That is, the sensitivity is improved during reception, and the transmission output is improved during transmission. Also, since the dielectric bodies 34 are merely added, an increase in the costs can be minimized.

The present invention can be applied to not only the folding portable radio device 1 and the straight type portable radio device 2 as described above, but also a slide type portable radio device having two housings in which one housing slides with respect to the other housing to conduct open and close operation. Also, the present invention can be applied to a PDA and a notebook computer having a communication function, and a radio device such as a transceiver.

The present invention has been described in detail and with reference to specific embodiments, and it would be obvious to an ordinary skilled person that various modifications and corrections can be conducted without deviating from the split and scope of the present invention.

The present invention is based on Japanese Patent Application No. 2009-00615 filed on Jan. 6, 2009, and content thereof is incorporated herein by reference.

### INDUSTRIAL APPLICABILITY

According to the present invention, the power absorption into the human face or hand can be reduced at the low costs, and the speech performance is improved. The present invention is applicable to a portable radio device such as a cellular phone or a PHS.

### DESCRIPTION OF REFERENCE SIGNS

1, 2 portable radio device
10A upper housing
10B lower housing
11 hinge part
12, 31 circuit board
13, 32 radio circuit
14, 33 antenna element
15 microphone
16 cover
17 sub-display unit
18 camera
19 speaker
20, 34 dielectric body
30 housing

1. A portable radio device comprising:
a housing made of non-conductor having a first permittivity;
a circuit board disposed in the housing;
a radio circuit disposed on the circuit board;
an antenna element connected to the radio circuit; and
a dielectric body disposed substantially in a center of the housing in a lateral direction thereof and having a second permittivity higher than the first permittivity.

2. A portable radio device comprising:
a first housing made of non-conductor having a first permittivity;
a second housing made of non-conductor having the first permittivity;
a hinge part that rotatably couples the first housing and the second housing;
a circuit board disposed in the second housing;
a radio circuit disposed on the circuit board;
an antenna element connected to the radio circuit and disposed closer to the hinge part in the second housing; and
a dielectric body disposed substantially in a center of at least one of the first housing and the second housing in a lateral direction thereof and having a second permittivity higher than the first permittivity.

3. The portable radio device according to claim 1, comprising:
a sound emitting unit,
wherein the dielectric body is disposed on an opposite side of the sound emitting unit in a thickness direction of the housing.

4. The portable radio device according to claim 2,
wherein the dielectric body is disposed in each of the first housing and the second housing, and the permittivity of the dielectric body disposed in the first housing is different from the permittivity of the dielectric body disposed in the second housing.

5. The portable radio device according to claim 2, comprising:
a sound emitting unit,
wherein the dielectric body and the sound emitting unit are disposed in one of the first housing and the second housing, and
wherein the dielectric body is disposed on an opposite side of the sound emitting unit in a thickness direction of the one of the first housing and the second housing.
